(19) United States
(12) Patent Application Publication
(10) Pub. No.: US 2012/0138651 A1
(43) Pub. Date: Jun. 7, 2012

(54) WEARABLE POCKET

(76) Inventor: Tamara Yvonne Kryklywicz, Calgary (CA)

(21) Appl. No.: 13/370,923

(22) Filed: Feb. 10, 2012

Related U.S. Application Data
(63) Continuation-in-part of application No. 29/380,118, filed on Nov. 30, 2010, now Pat. No. D654264.
(60) Provisional application No. 61/441,791, filed on Feb. 11, 2011.

(51) Int. Cl. A45C 15/00; B31B 1/26

(52) U.S. Cl. 224/576; 493/243

(57) ABSTRACT

The present disclosure is directed at a wearable pocket that can beneficially be used to store valuables securely in a convenient location, such as along a calf of a wearer. The wearable pocket includes a permanently unitary stretchable band. First and second pockets are located on a side of the band. Each of the first and second pockets have mouths movable between open and closed positions. In the closed position, the mouth of the first pocket is located within the second pocket; consequently, the interiors of both the first and second pockets are not simultaneously accessible. In the open position, the mouth of the first pocket is outside the second pocket and separated from the mouth of the second pocket. This allows the wearer to simultaneously access the interiors of both the first and second pockets.

### CROSS REFERENCE TO RELATED APPLICATION

This application is a continuation-in-part of U.S. patent application Ser. No. 29/380,118, filed Nov. 30, 2010 and entitled “Wearable Pocket,” which is hereby incorporated by reference in its entirety.

Pursuant to 35 U.S.C. §119(e), this application also claims the benefit of provisional U.S. Patent Application No. 61/441,791, filed Feb. 11, 2011 and entitled “Wearable Pocket,” which is hereby incorporated by reference in its entirety.

### TECHNICAL FIELD

The present disclosure is directed at a wearable pocket and a method for making same.

### BACKGROUND

Often, it can be convenient or even necessary not to carry valuables such as keys or money in typical places such as in purses or in jacket pockets. For example, when jogging or participating in other athletics, it may simply be impractical and uncomfortable to carry a purse or to wear a jacket. Additionally, while travelling, thieves may be more likely to target conspicuous locations such as purses and jacket pockets. Consequently, people in certain circumstances may prefer not to store their valuables in conventional places such as purses, bags, jackets, and the like.

### BRIEF DESCRIPTION OF THE DRAWINGS

In the accompanying drawings, which illustrate one or more exemplary embodiments:

FIG. 1 depicts a wearable pocket located on a limb (a calf) of a wearer with a removable pouch insert protruding from the pocket, according to one embodiment.

FIG. 2 depicts the wearable pocket of FIG. 1 in which the pouch insert is contained entirely within the pocket.

FIG. 3 depicts the wearable pocket of FIG. 1 in which flexible mouths of first and second pockets, which form part of the wearable pocket, are biased in an open position to allow access to the interior of the wearable pocket.

FIGS. 4(a) to (d) depict a method for making the wearable pocket of FIG. 1, according to another embodiment.

### SUMMARY

According to a first aspect, there is provided a wearable pocket having a stretchable band circumscribing an aperture sized to receive a portion of the body of a wearer and to compress and be frictionally retained on the body, the band being a permanently unitary piece of material. The wearable pocket also includes first and second pockets located on a side of the band that each have an interior and a flexible mouth through which their respective interiors are accessible. The interiors are at least partially distinct from each other and the mouths of the pockets are flexible between a closed position in which a coverable portion of the mouth of the first pocket is inside the second pocket and an open position in which the coverable portion is outside the second pocket and separated from the mouth of the second pocket to allow simultaneous access to both the interiors.

A first end of the wearable pocket may be delineated by a first crease of fabric along which the band and the first pocket are joined and a second end of the wearable pocket may be delineated by a second crease of fabric along which the band and the second pocket are joined.

Each of the flexibly shaped mouths may also include elastic material such that each of the mouths returns to the closed position when unbiased by an external force. The first and second pockets may be made entirely of elastic fabric.

The coverable portion of the mouth of the first pocket may include all of the mouth of the first pocket.

The first end of the band and the mouth of the first pocket may be disposed at opposite ends of the first pocket, and the second end of the band and the mouth of the second pocket may be disposed at opposite ends of the second pocket.

The first pocket, the second pocket, and the band may be secured together at two separate securing locations located along one or both of the mouths of the first and second pockets.

Each of the first and second pockets may extend at least half way from one of the ends of the wearable pocket to the other of the ends of the wearable pocket. Alternatively or additionally, the coverable portion may extend at least about 25% from one of the ends of the wearable pocket to the other of the ends of the wearable pocket.

The band may include anti-microbial material.

According to another aspect, there is provided a method for making a wearable pocket from a stretchable band of fabric formed from a permanently unitary piece of material. The method includes turning one end of the band inside out to form a first pocket having a first sheath of fabric folded on to a side of the band along a first crease, wherein a portion of an edge of the first sheath opposite the first crease comprises a flexible mouth of the first pocket through which an interior of the first pocket is accessible; turning the other end of the band inside out to form a second pocket comprising a second sheath of fabric folded on to the side of the band along a second crease, wherein a portion of an edge of the second sheath opposite the second crease comprises a flexible mouth of the second pocket through which an interior of the second pocket is accessible; positioning a coverable portion of the mouth of the first pocket into a closed position inside the second pocket such that the mouths of the pockets are flexible between the closed position and an open position in which the coverable portion is outside the second pocket and separated from the mouth of the second pocket to allow simultaneous access to both the interiors; and securing the first and second sheaths of fabric to the band at two securing locations along the band.

Each of the flexibly shaped mouths may also include elastic material such that each of the mouths returns to the closed position when unbiased by an external force.

The first and second pockets may be made entirely of elastic fabric.

The coverable portion of the mouth of the first pocket may include all of the mouth of the first pocket.

The first pocket, the second pocket, and the band may be secured together at two separate securing locations located along one or both of the mouths of the first and second pockets.

Each of the first and second pockets can extend at least half way from one of the ends of the wearable pocket to the other of the ends of the wearable pocket. Alternatively or additionally, the coverable portion may extend at least about 25% from one of the ends of the wearable pocket to the other of the ends of the wearable pocket.

The band may include anti-microbial material.

According to another aspect, there is provided a wearable pocket including a stretchable band having an underside and an exterior side and comprising portions of material permanently joined together; and first and second pockets located on the exterior side each having mouths movable between closed and open positions, wherein the mouth of the first pocket is located within the second pocket when in the closed position and wherein the mouth of the first pocket is outside the second pocket and separated from the mouth of the second pocket when in the open position.

According to another aspect, there is provided a kit including any of the foregoing aspects of the wearable pocket. The kit also includes a removable pouch insert sized to fit within the combined interiors of the first and second pockets.

The interior of one of the first and second pockets may include a first fastener that is matable with and detachably couplable to a second fastener located on the pouch insert. For example, the first fastener may be a first set of snaps and the second fastener located on the pouch insert may be a second set of snaps, detachably couplable to the first set of snaps, for coupling the pouch insert to the wearable pocket.

The wearable pocket extends lengthwise in a longitudinal direction between two ends and one dimension of the pouch insert (e.g.: the length of width of the pouch insert) may be sized to equal or exceed the length of the wearable pocket such that when the pouch insert is within the wearable pocket the ends apply a force against the pouch insert in the longitudinal direction. This helps to retain the pouch insert snugly within the wearable pocket.

The pouch insert may be waterproof or water resistant.

### DETAILED DESCRIPTION

Directional terms such as “top”, “bottom”, “upwards”, “downwards”, “vertically” and “laterally” are used in the following description for the purpose of providing relative reference only, and are not intended to suggest any limitations on how any article is to be positioned during use, or to be mounted in an assembly or relative to an environment.

The embodiments described herein are directed at a wearable pocket that can be used to store valuables in a secure location snugly to a wearer's body. The wearable pocket includes a stretchable band of material that is sized to fit snugly over and to be frictionally retained on a part of the body of the wearer, such as the wearer's calf or arm. The band is a permanently unitary piece of material. By “permanently unitary”, it is meant that the band is formed from one or more pieces of material that are permanently joined together using, for example, stitching or a permanent adhesive, or that the band is formed from a single piece of material whose portions did not have to be joined together (e.g.: the band may be knit, or may be a synthetic material that is molded or extruded). As discussed in greater detail below, this is advantageous over joining pieces of material using some kind of releasable fastener, such as Velcro™ hook-and-loop fasteners. Additionally, the wearable pocket described herein can optionally be used with a removable pouch insert that is sized to fit within the wearable pocket. The wearer may put all of his or her valuables in the pouch insert, which facilitates easy removal of all the valuables at once. The pouch insert may also be waterproof or water resistant, which is particularly beneficial when it is used during athletics so as to prevent the valuables from being soaked with sweat.

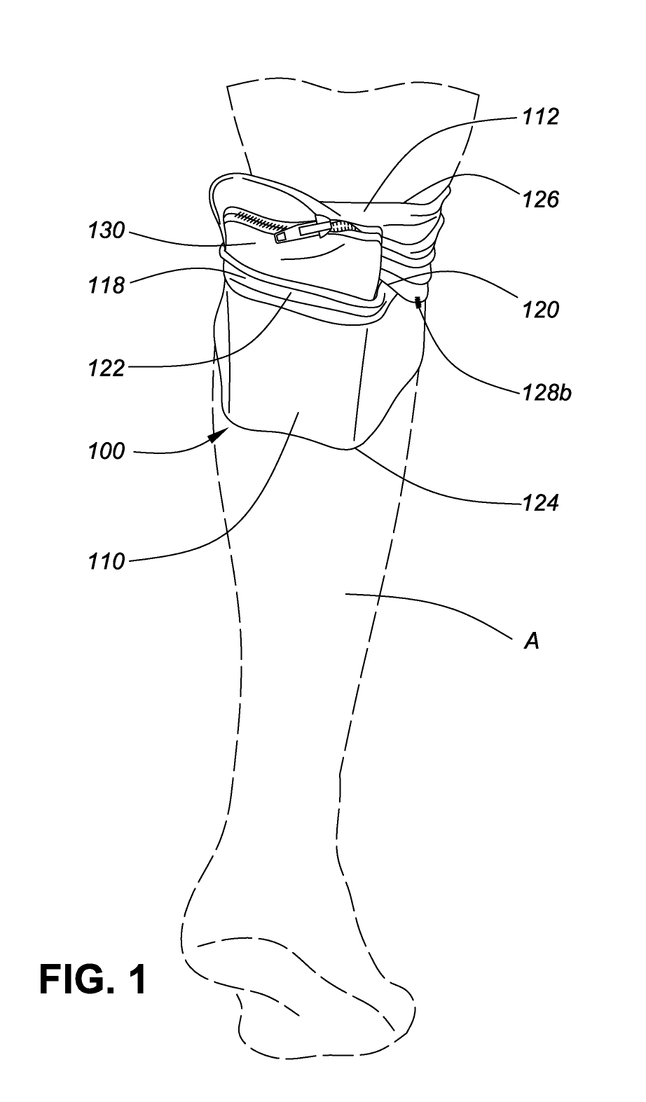

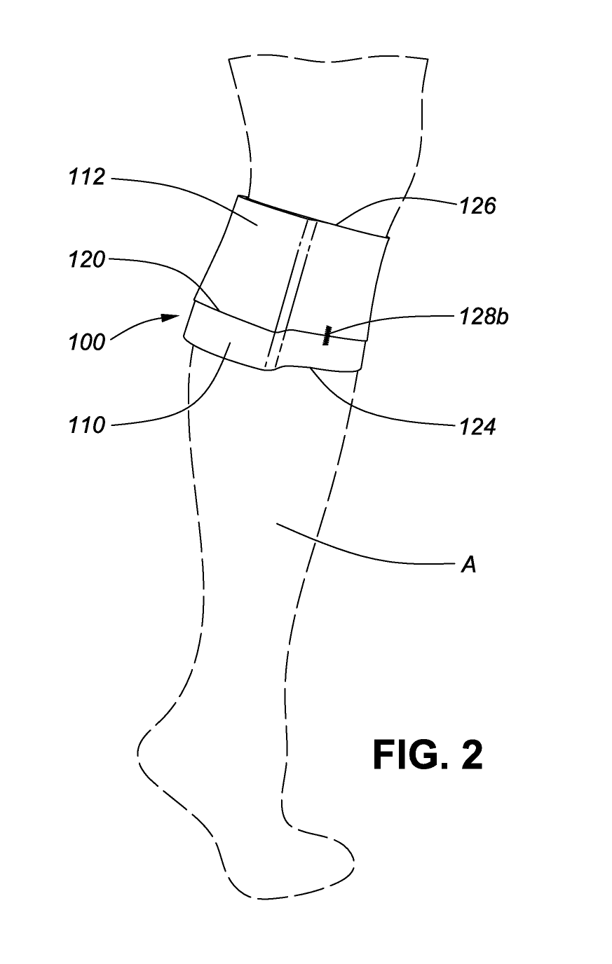

Referring now to FIGS. 1 to 3, there is depicted a wearable pocket 100 according to a first embodiment. The wearable pocket 100 includes a stretchable band 102 of material. As the stretchable band 102 of material is elastic, it can be fitted onto a limb of a wearer. In FIGS. 1 and 2, the wearable pocket 100 is sized to have a diameter slightly less than the wearer's calf A. Consequently, when the wearer slides the wearable pocket 100 on to his or her calf A, the wearable pocket 100 will compress the calf A and be frictionally retained on to the calf A. To wear the wearable pocket 100, the calf A is inserted through an aperture 104 delineated by the band 102. Compression of the band 102 around the calf A results in frictional force between the calf A and an underside 106 of the band 102. The band 102 also has an exterior side 108 that is opposite the underside 106 of the band 102 and that faces away from the calf A when the band 102 is worn.

Optionally, the stretchable band 102 may be manufactured using a moisture-wicking fabric. A moisture-wicking fabric helps to remove sweat from the skin, and helps to mitigate any feelings of dampness or stickiness that can result when moisture is trapped against the skin's surface. Fabricating the wearable pocket 100 from a moisture-wicking fabric is particularly beneficial when the wearable pocket 100 is to be used during athletics. Additionally or alternatively, the band 102 may include an anti-microbial material. The anti-microbial material can be added to the band 102 during the dyeing process or during weaving. Beneficially, anti-microbial material inhibits bacterial growth, which can reduce the risk of infection and prevent the band 102 from smelling after long periods of use.

Forming the band 102 by permanently joining together one or more pieces of material (e.g. through sewing) is beneficial over using releasable fasteners, such as hook-and-loop fasteners or a zipper, for reasons including simplicity of manufacture and use. For example, the band 102 may be manufactured by sewing together two ends of a strip of elastic fabric. Simply sewing two ends of fabric together is faster and simpler than sewing fasteners on to each of the ends of the fabric, and facilitates ease of manufacturing. Furthermore, permanently joining the pieces of material together means that any detrimental side effects of using releasable fasteners are avoided. For example, hooks used in hook-and-loop fasteners may accidentally attach to the fabric of the band itself and not just to their corresponding loops. Zippers can become jammed and may catch folds of skin while being zipped. Given the repetitive movement that releasable fasteners typically have to endure, they may also be more prone to mechanical failure than permanent fastening means such as sewing or adhesive.

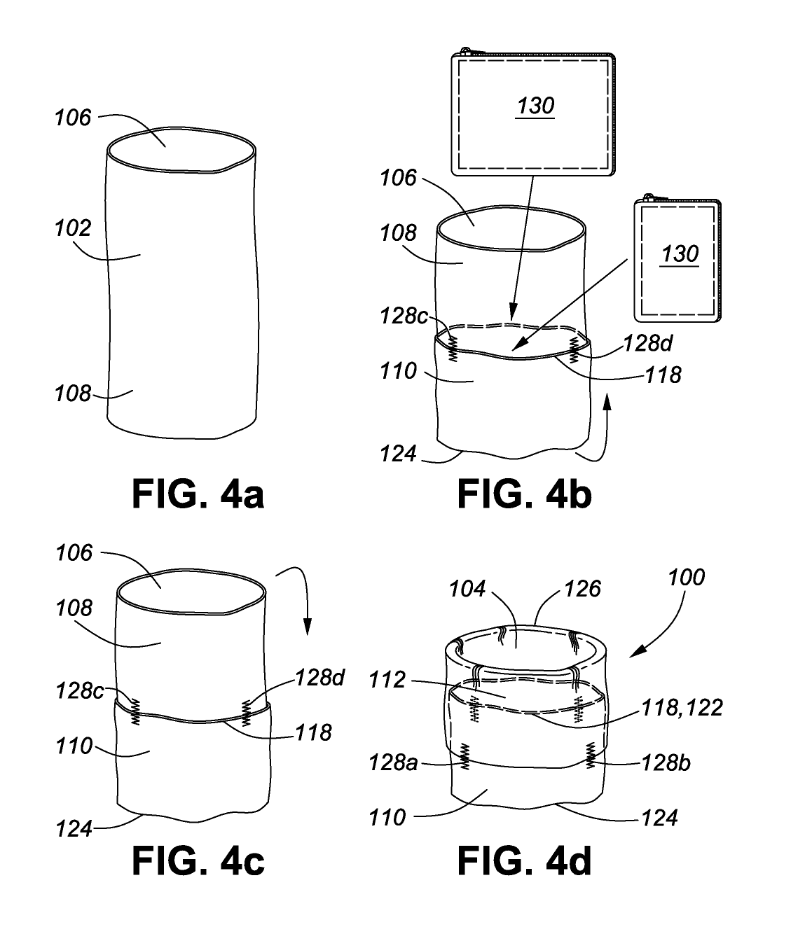

At one end of the exterior side 108 of the wearable pocket 100 is a first pocket 110. As discussed in more detail with respect to FIG. 4, below, in the present embodiment the first pocket 110 is formed by turning one end of the band 102 inside out. This results in a first sheath of fabric (unlabelled), which is folded along a first crease 124 of the wearable pocket 100, covering a portion of the exterior side 108 of the band 102. The first pocket 110 has an interior 114 comprising a portion of the volume between the first sheath of fabric and the exterior side 108 of the band 102 that it overlaps. A portion of the edge of the first sheath opposite the first crease 124 forms a mouth of the first pocket 110 (“first pocket mouth” 118). In order to insert valuables into the first pocket 110, the first pocket mouth 118 can be lifted away from the exterior side 108 of the band 102, and the valuables can be inserted into the resulting gap.

At the other end of the exterior side 108 of the wearable pocket 100 is a second pocket 112. Similar to the first pocket 110, in the present embodiment the second pocket 112 is formed by turning inside out the other end of the band 102. This results in a second sheath of fabric (unlabelled), which is folded along a second crease 126 of the wearable pocket 100, covering a portion of the exterior side 108 of the band 102 and the first pocket mouth 118. The second pocket 112 has an interior 116 that comprises a portion of the volume between the second sheath of fabric and the exterior side 108 of the band 102 that it overlaps. A portion of the edge of the second sheath opposite the second crease 126 forms a mouth of the second pocket 112 (“second pocket mouth” 120). In order to insert valuables into the second pocket 112, the second pocket mouth 118 can be lifted away from the exterior side 108 of the band 102, and the valuables can be inserted into the resulting gap. Exemplary valuables that can be stored include IPod™ music players and IPhone™ telephones.

The first and second sheaths of fabric and the underlying band 102 are secured together at four securing locations 128a-d on the wearable pocket 100 (FIGS. 1 and 2 show only one of the securing locations 128b; all four of the securing locations 128a-d are visible in FIG. 4(d)). In the present embodiment, a bartack having dimensions of about 1/16 of an inch in width and 1 inch in length is used to secure the three layers of fabric together at two of the securing locations 128a,b, while a similar bartack is used to secure the first sheath of fabric and the underlying band 102 together the each of the other securing locations 128c,d. In alternative embodiments, the layers may be secured to each other differently. For example, there may be stitching securing all three layers together that extends from one end of the wearable pocket 100 to the other. Securing the first and second sheaths of fabric to the band 102 at the securing locations 128a,b and the first sheath of fabric to the band 102 at the other securing locations 128c,d prevents the first and second sheaths from unfolding and the wearable pocket 100 from losing its shape while it is being used.

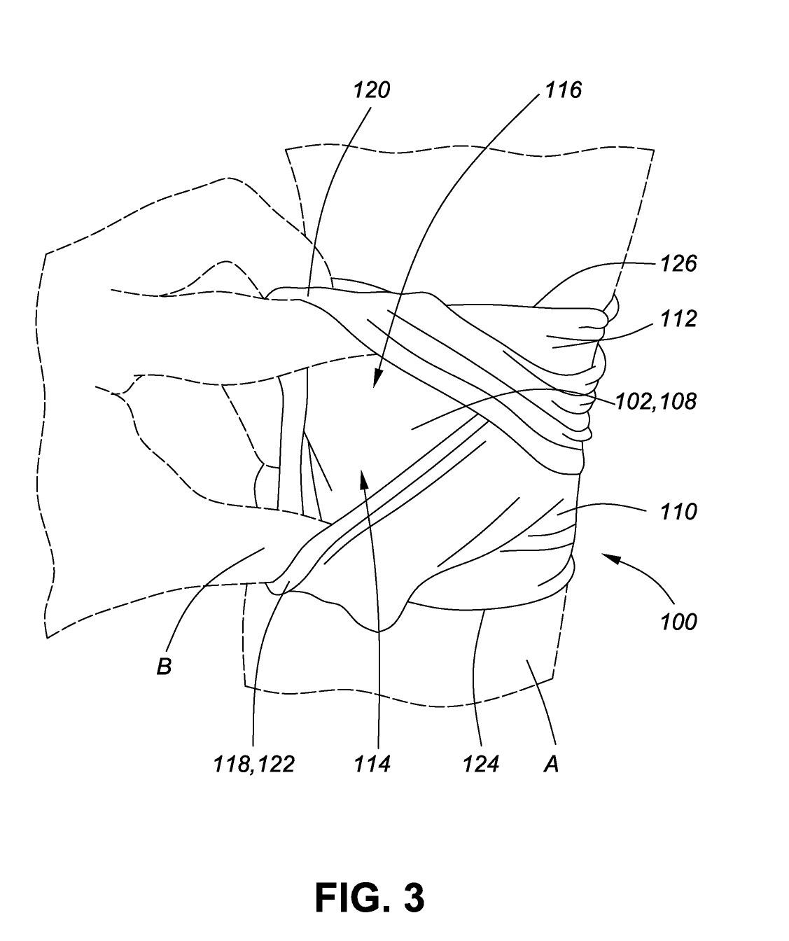

In the present embodiment, as the first and second pockets 110, 112 are formed from the same material as the band 102, the first and second pockets 110, 112 are also elastic and compress against the calf A when the wearable pocket 100 is worn. In its default, quiescent position, the first pocket mouth 118 is contained entirely within the second pocket 112 and, when no external forces are being applied to the wearable pocket 100 to open it (e.g.: by the wearer's fingers, as discussed in more detail below in respect particularly of FIG. 3), the first pocket mouth 118 is inaccessible to the wearer and the second pocket mouth 120 is pressed against the first sheath of fabric. Consequently, the interiors 114, 116 of the first and second pockets 110, 112 are inaccessible, and the wearable pocket 100 is in a closed position. In the present embodiment, the entirety of the first pocket mouth 118 is contained within the second pocket 112 (i.e. covered by the second sheath of fabric) when the wearable pocket 100 is in the closed position; consequently, the entirety of the first pocket mouth 118 is coverable by the second sheath of fabric. This portion of the first pocket mouth 118 that is contained within the second pocket 112 when the wearable pocket 100 is in the closed position is the “coverable portion” of the first pocket mouth 118. In alternative embodiments (not depicted), the coverable portion of the first pocket mouth 118 is less than the entirety of the first pocket mouth 118. For example, the first pocket mouth 118 may be notched such that the notches of the first pocket mouth 118 are not contained within the second pocket 112, even when in the closed position. However, the coverable portions of the first pocket mouth 118, which exclude the notches, are sufficient to keep the first pocket 110 closed when the coverable portion is contained within the second pocket 112.

Regarding FIG. 3 in particular, the wearer may use his or her fingers B to take the first pocket mouth 118 out of the second pocket 112 and to separate the first and second pocket mouths 118, 120 from each other; when the first and second pocket mouths 118, 120 are separated in this way, the wearable pocket 100 is in an open position. In the open position the wearer is granted simultaneous access to the combined interiors 114, 116 of the first and second pockets 110, 112 and may insert valuables therein. Because the first and second pockets 110, 112 are secured to the band 102 at the securing locations 128a-d, the first and second pocket mouths 118, 120 are under tension when biased by an external force (e.g.: from the fingers B) into the open position. If the first and second pocket mouths 118, 120 are lined with or composed of a sufficiently elastic material and are under sufficient tension when in the open position, they may automatically return to the closed position when the external force is removed (e.g.: when the fingers B are removed). The pocket mouths 118, 120 may be elastic by virtue of being part of the first and second sheaths of fabric, which may themselves be elastic, or alternatively bands of sufficiently elastic material may be used to line the pocket mouths 118, 120.

Referring now to FIG. 1 in particular, there is shown a removable pouch insert 130 that is inserted into and that protrudes from the first pocket 110. The pouch insert 130 can be used to store several valuables (e.g.: keys, coins, jewelry); storing several valuables in the pouch insert 130 allows them to be quickly and simultaneously removed from the wearable pocket 100 by removing the relatively large and easy to grasp pouch insert 130. Storing the valuables in the pouch insert 130 also helps prevent them from shifting while in the interior of the wearable pocket 100. Optionally, the pouch insert 130 may be fabricated from a waterproof or water resistant material to prevent liquids, such as sweat, from soaking any of the valuables. Alternatively or additionally, the pouch insert 130 may be used in conjunction with a waterproof pouch such as the Loksak™ waterproof pouch.

Referring now to FIG. 2 in particular, the pouch insert 130 has been inserted entirely into the interior of the second pocket 112 and the second pocket mouth 120 has been moved over the first pocket mouth 110. In other words, the wearable pocket 100 is in the closed position and the pouch insert 130 is contained within the interior of the wearable pocket 100 (i.e.: the combined interiors 116, 118 of the first and second pockets 110, 112). In the closed position, the valuables contained within the wearable pocket 100 are secured within the wearable pocket 100 by virtue of the elasticity of the first and second sheaths of material, which apply compressive force to the calf A and, consequently, helps to keep the valuables pressed against the calf A.

The pouch insert 130 may be sold as part of a kit that includes the wearable pocket 100. Furthermore, although not shown in the present embodiment, the interior of one of the first and second pockets 110, 112 and the exterior of the pouch insert 130 may have fasteners, such as snaps, attached thereon. These fasteners can be used to detachably couple the pouch insert 130 to the interior of the wearable pocket 100, which can provide the wearer with more assurance that the pouch insert 130 is resistant to both theft and accidental loss. In addition to snaps, other examples of the fasteners include hook and loop fasteners such as Velcro™ and button/button hole pairs.

In the present embodiment the coverable portion extends at least about 25% from one of the ends of the wearable pocket to the other of the ends of the wearable pocket. This is beneficial in that it corresponds to the two pockets 110, 112 overlapping to a relatively high degree, which helps to ensure that the valuables remain contained within the wearable pocket 100 even when it is subject to rapid movements or vibrations, as may occur during athletics. Furthermore, this relatively high degree of overlap increases the difficulty a thief may have gaining access to the interior of the wearable pocket 100. Additionally, in the present embodiment, the first and second sheaths of material each extend more than 50% from one end of the wearable pocket 100 to the other. This is beneficial in that each of the pockets 110, 112 is sufficiently long (i.e. the first and second pocket mouths 118, 120 are sufficiently far from the first and second creases 124, 126, respectively) that the valuables stored within the wearable pocket 100 are more likely to be covered by both the first and second sheaths of fabric, thus helping to securely hold the valuables, than if one of the sheaths extended substantially less than 50% along the wearable pocket 100.

Referring now to FIGS. 4(a)-(d), there is illustrated a method for making the wearable pocket 100. In FIG. 4(a), a manufacturer begins with the stretchable band 102 of fabric, a portion of the underside 106 of which contacts the calf A when worn. The first and second pockets 110, 112 will eventually be placed on to the exposed side 108 of the band 102. In FIG. 4(b), to form the first pocket 110 one end of the band 102 is turned inside out, which results in the first sheath of material being folded, along the first crease 124, on to the exterior side 108 of the band 102. A portion of the edge of the first sheath located opposite the first crease 124 forms the first pocket mouth 118. The edge of the first sheath is secured to the band 102 at the two securing locations 128c,d using bartacks; in order to increase the tension applied to the first pocket mouth 118 when the wearable pocket is in the open position, the bartacks are applied across the first pocket mouth 118. In FIG. 4(c), to form the second pocket 112 the other end of the band 102 is turned inside out, which results in the second sheath of material being folded, along the second crease 126, on to the exterior side 108 of the band 102 and over the first pocket mouth 118. A portion of the edge of the second sheath of material located opposite the second crease 126 forms the second pocket mouth 120. Referring now to FIG. 4(d), the first and second pockets 110, 112 and the band 102 are secured together at the two securing locations 128a,b using bartacks; in order to increase the tension applied to the second pocket mouth 120 when the wearable pocket is in the open position, the bartacks are applied across the second pocket mouth 120. In an alternative embodiment (not shown), the bartacks may alternatively be applied across only one of the two pocket mouths 118, 120. In the present embodiment, the securing locations 128c,d applied to the first pocket mouth 118 are about ⅓ of the perimeter of the band 102 apart; when the band 102 is stretched into a tubular shape, this translates to the two securing locations 128c,d being about 120° apart; the securing location 128a,b applied to the second pocket mouth 120 are similarly spaced.

In FIG. 4(b), two variants of the pouch insert 130 are shown: a passport-sized pouch insert 130a, and a card-sized pouch insert 130b. Each of the pouch inserts 130a,b has two rectangular faces circumscribed by four sides. As alluded to by their names, the passport-sized pouch insert 130a is sized so that a typically sized passport fits snugly within it, and the card-sized pouch insert 130b is sized so that a typical credit card fits snugly within it. In the depicted embodiment, the longer sides of the card-sized pouch insert 130b are the same length as the shorter sides of the passport-sized pouch insert 130a: approximately 3⅜ inches (8.57 cm). The card-sized pouch insert 130b can be inserted into the wearable pocket 100 so that its longer side is parallel to the longitudinal axis of the band 102, in which case it can fit in the 120° segment of the interior of the wearable pocket 100. Additionally or alternatively, the passport-sized pouch insert 130a can be inserted into the wearable pocket 100 so that its shorter side is parallel to the longitudinal axis of the band 102, in which case it can fit into the 240° segment of the interior of the wearable pocket 100. In the depicted embodiment, the length of the wearable pocket 100 from the first crease 124 to the second crease 126 is equal to or slightly less than the lengths of the longer side of the card-sized pouch insert 130b and the shorter side of the passport-sized pouch insert 130a. Consequently, when either of the pouch inserts 130a,b is inserted into the wearable pocket 100, the pouch inserts 130a,b are compressed by the ends of the wearable pocket 100 such that forces are applied in a longitudinal direction against the sides of the pouch inserts 130a,b adjacent to the first and second creases 124,126. This occurs because the wearable pocket 100 is stretched slightly in the longitudinal direction by the insertion of the pouch inserts 130a,b, and the first and second creases 124,126 therefore press against the sides of the pouch inserts 130a,b. This compression of the pouch inserts 130a,b by the band 102 helps retain the pouch inserts 130a,b snugly within the wearable pocket 100.

In FIG. 4(d), the wearable pocket 100 is shown in the closed position and each of the ends of the wearable pocket 100 (the first and second creases 124, 126) and the first and second pocket mouths 118, 120 are parallel. However, in alternative embodiments the first and second pocket mouths 118, 120 and the ends of the wearable pocket 100 are not parallel. For example, as discussed above, one of the pocket mouths 118, 120 may be notched or take on some other shape.

Additionally, in the foregoing embodiments, the first and second pockets 110, 112 are located opposite each other. That is, the ends of each of the pockets 110, 112 are located on opposite ends of the wearable pocket 100 and items (or portion of items) inserted into different pockets 110, 112 are inserted towards different ends of the wearable pocket 100. However, in alternative embodiments this may not be the case. For example, the ends of both the first and second pockets 110, 112 may share the same end of the wearable pocket 100. In one such embodiment, the pockets 110, 112 may be shaped such that the pocket mouths 118, 120 extend parallel to the longitudinal axis of the wearable pocket 100 and overlap. So long as the interiors of the pockets 110, 112 are at least partially distinct from each other (i.e. do not entirely overlap), the total storage space that the wearable pocket 100 offers will be the combination of the interiors of the first and second pockets 110, 112, and this will beneficially be greater than the storage space offered by the interior of either of the pockets 110, 112 alone.

While the foregoing embodiments have been shown as having two pockets 110, 112, in alternative embodiments more than two pockets 110, 112 may be used.

In the foregoing embodiments, the wearable pocket 100 is manufactured from a single sheet of fabric. In alternative embodiments, this may not be the case. For example, multiple pieces of fabric may be sewn or adhered together to form the band 102. Additionally, one or both of the first and second pockets may be sewn on to the exterior side 108 of the band 102 instead of being formed by folding a portion of the band 102 on to itself.

Instead of being placed on a limb of the wearer, a sufficiently large embodiment of the wearable pocket 100 may also be worn around the torso or abdomen of the wearer. This would have the added benefit of the wearable pocket 100 acting as a girdle and helping to make the wearer appear thin.

In another alternative embodiment (not shown), the wearable pocket 100 may be turned inside out such that the first and second pockets 110, 112 are on the underside 106 of the band 102 when worn. This provides an additional level of security, as in this alternative embodiment the first and second pocket mouths 118, 120 are pressed against the wearer's body when the wearable pocket 100 is worn, making it more difficult for a thief to gain access to the interior of the pocket 100 or for the valuables to accidentally fall out of the pocket 100. For example, should the wearer decide to go swimming while using the wearable pocket 100, it may be beneficial to use the wearable pocket 100 with the first and second pocket mouths 118, 120 pressed against the wearer's body so as to reduce the amount of water that seeps into the first and second pockets 110, 112 and to lower the likelihood of losing the stored valuables underwater. Manufacturing this alternative embodiment can be done by following the method described in respect of FIGS. 4(a)-(d), above, and by then turning the entire wearable pocket 100 inside out.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A wearable pocket, comprising:
(a) a stretchable band circumscribing an aperture sized to receive a portion of the body of a wearer and to compress and be frictionally retained on the body, the band comprising a permanently unitary piece of material; and
(b) first and second pockets located on a side of the band and each having an interior and a flexible mouth through which their respective interiors are accessible, wherein the interiors are at least partially distinct from each other and the mouths of the pockets are flexible between a closed position in which a coverable portion of the mouth of the first pocket is inside the second pocket and an open position in which the coverable portion is outside the second pocket and separated from the mouth of the second pocket to allow simultaneous access to both the interiors.

2. A wearable pocket as claimed in claim 1 wherein a first end of the wearable pocket is delineated by a first crease of fabric along which the band and the first pocket are joined and a second end of the wearable pocket is delineated by a second crease of fabric along which the band and the second pocket are joined.

3. A wearable pocket as claimed in claim 1 wherein each of the flexibly shaped mouths further comprises elastic material such that each of the mouths returns to the closed position when unbiased by an external force.

4. A wearable pocket as claimed in claim 1 wherein the first and second pockets are made entirely of elastic fabric.

5. A wearable pocket as claimed in claim 1 wherein the coverable portion of the mouth of the first pocket comprises all of the mouth of the first pocket.

6. A wearable pocket as claimed in claim 2 wherein the first end of the band and the mouth of the first pocket are disposed at opposite ends of the first pocket, and the second end of the band and the mouth of the second pocket are disposed at opposite ends of the second pocket.

7. A wearable pocket as claimed in claim 1 wherein the first pocket, the second pocket, and the band are secured together at two separate securing locations located along one or both of the mouths of the first and second pockets.

8. A wearable pocket as claimed in claim 6 wherein each of the first and second pockets extends at least half way from one of the ends of the wearable pocket to the other of the ends of the wearable pocket.

9. A wearable pocket as claimed in claim 1 wherein the coverable portion extends at least about 25% from one of the ends of the wearable pocket to the other of the ends of the wearable pocket.

10. A wearable pocket as claimed in claim 1, further comprising:
a removable pouch insert sized to fit within the combined interiors of the first and second pockets.

11. A wearable pocket as claimed in claim 10 wherein the wearable pocket extends lengthwise in a longitudinal direction between two ends and wherein one dimension of the pouch insert is sized to equal or exceed the length of the wearable pocket such that when the pouch insert is within the wearable pocket the ends apply a force against the pouch insert in the longitudinal direction.

12. A wearable pocket as claimed in claim 10 wherein the pouch insert is waterproof or water resistant.

13. A method for making a wearable pocket from a stretchable band of fabric comprising a permanently unitary piece of material, the method comprising:
(a) turning one end of the band inside out to form a first pocket comprising a first sheath of fabric folded on to a side of the band along a first crease, wherein a portion of an edge of the first sheath opposite the first crease comprises a flexible mouth of the first pocket through which an interior of the first pocket is accessible;
(b) turning the other end of the band inside out to form a second pocket comprising a second sheath of fabric folded on to the side of the band along a second crease, wherein a portion of an edge of the second sheath opposite the second crease comprises a flexible mouth of the second pocket through which an interior of the second pocket is accessible;
(c) positioning a coverable portion of the mouth of the first pocket into a closed position inside the second pocket such that the mouths of the pockets are flexible between the closed position and an open position in which the coverable portion is outside the second pocket and separated from the mouth of the second pocket to allow simultaneous access to both the interiors; and
(d) securing the first and second sheaths of fabric to the band at two securing locations along the band.

14. A method as claimed in claim 13 wherein each of the flexibly shaped mouths further comprises of elastic material such that each of the mouths returns to the closed position when unbiased by an external force.

15. A method as claimed in claim 13 wherein the first and second pockets are made entirely of elastic fabric.

16. A method as claimed in claim 13 wherein the coverable portion of the mouth of the first pocket comprises all of the mouth of the first pocket.

17. A method as claimed in claim 13 wherein the first pocket, the second pocket, and the band are secured together at two separate securing locations located along one or both of the mouths of the first and second pockets.

18. A method as claimed in claim 13 wherein each of the first and second pockets extends at least half way from one of the ends of the wearable pocket to the other of the ends of the wearable pocket.

19. A method as claimed in claim 13 wherein the coverable portion extends at least about 25% from one of the ends of the wearable pocket to the other of the ends of the wearable pocket.

20. A wearable pocket, comprising:
(a) a stretchable band having an underside and an exterior side and comprising portions of material permanently joined together; and
(b) first and second pockets located on the exterior side each having mouths movable between closed and open positions, wherein the mouth of the first pocket is located within the second pocket when in the closed position and wherein the mouth of the first pocket is outside the second pocket and separated from the mouth of the second pocket when in the open position.
